(19) United States
(12) Patent Application Publication
(10) Pub. No.: US 2008/0267455 A1
(43) Pub. Date: Oct. 30, 2008

(54) Method for Movement Compensation of Image Data

(75) Inventors: Michael Grass, Buchholz in der Nordheide (DE); Thomas Koehler, Norderstedt (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/097,568

(22) PCT Filed: Dec. 11, 2006
(86) PCT No.: PCT/IB2006/054727

§ 371 Date: Jun. 16, 2008

(30) Foreign Application Priority Data
Dec. 20, 2005 (EP) 05112450.1

(51) Int. Cl. G06K 9/00

(52) U.S. Cl. 382/107; 382/131

(57) ABSTRACT

According to an exemplary embodiment a method for movement compensation of image data of an object of interest comprises receiving projection data, receiving motion vector field data, and dividing the motion vector field data into a number of layers of motion vector field data. Furthermore, the method comprises generating motion compensated projection data by projecting at least one of the number of layered motion vector field data onto the projection data and applying a two dimensional motion compensation on the projection, and generating image data of at least one voxel by back-projecting the movement compensated projection data.

The invention relates to a method for movement compensation of image data, a reconstruction unit for movement compensation of image data, a tomography system, a computer readable medium and a program element.

Computed tomography (CT) is a process of using digital processing to generate a three-dimensional image of the internal of an object under investigation (object of interest) from a series of two-dimensional x-ray images taken around a single axis of rotation. The reconstruction of CT images can be done by applying appropriate algorithms.

A basic principle of CT imaging is that projection data of an object under examination are taken by detectors of a CT system. The projection data represent information of the object passed by radiation beams. To generate an image out of the projection data these projection data can be back-projected leading to a two-dimensional image, i.e. representing a disc. Out of a plurality of such two-dimensional images a so called voxel representation, i.e. a representation of three dimensional pixels, can be reconstructed. In case that the detectors are already arranged in form of a plane, two-dimensional projection data are achieved and the result of the back-projection is a three-dimensional voxel. This processing can be performed using two-dimensional helical reconstruction methods, where different parts of the detector data of one projection are backprojected into planes at different position, which may even have a different orientation. In modern, more sophisticated so called “cone-beam” reconstruction methods the projection data of two-dimensional detectors are directly back projected into a three-dimensional distribution of voxels in one single reconstruction step.

One important application of the computer tomography is the so-called cardiac computer tomography, which is related to the reconstruction of a three-dimensional image of a beating heart. In such an application the movement of the beating heart possibly distorts the reconstructed image by introducing some blurring. To reduce these distortions motion compensated reconstruction can be applied to the CT imaging in order to decrease the level of motion artefacts. When the motion is compensated for in a projection range—or maybe even in the complete set of projections—all of the projections which have been motion compensated may be used in the reconstruction process without introducing additional artefacts. This results in a higher signal to noise ratio than in non-motion compensated reconstruction and can be directly used to decrease the patient dose. Additionally, the motion compensated reconstruction process can result into an improvement of the temporal and the spatial resolution in the image data set.

It may be desirable to provide an alternative method for movement compensation of image data, a reconstruction unit for movement compensation of image data, a tomography system, a computer readable medium and a program element.

This need may be met by a method for movement compensation of image data, a reconstruction unit for movement compensation of image data, a tomography system, a computer readable medium and a program element according to the independent claims.

According to an exemplary embodiment a method for movement compensation of image data of an object of interest comprises receiving projection data representing the object of interest, receiving motion vector field data, and dividing the motion vector field data into a number of layers of motion vector field data. Furthermore, the method comprises generating motion compensated projection data by projecting at least one of the number of layered motion vector field data onto the projection data and applying a two dimensional motion compensation on the projection. Here the projected motion vectors may be used to calculate a motion compensated projection using a two dimensional motion compensation method, which may compensate for the object motion which occurred in the image layer, which may correspond to layer of the motion vector field which has been forward projected. The motion compensated projection is used to generate image data of at least one voxel in the image layer which corresponds to the motion vector field layer by back-projecting the movement compensated projection data.

According to an exemplary embodiment a reconstruction unit for an examination apparatus for examination of an object of interest is adapted for receiving projection data, for receiving motion vector field data, and for dividing the motion vector field data into a number of layers of motion vector field data. The reconstruction unit is further adapted for generating motion compensated projection data by projecting at least one of the number of layered motion vector field data onto the projection data, applying a two dimensional motion compensation on the projection, and for generating image data of at least one voxel by back-projecting the movement compensated projection data.

According to an exemplary embodiment a tomography system comprises a tomography unit and a reconstruction unit according to an exemplary embodiment of the present invention. The tomography unit is adapted to measure projection data of an object of interest and further adapted to transmit the projection data to the reconstruction unit.

According to an exemplary embodiment a computer readable medium is provided in which a program for producing an image based on projection data of a tomography system is stored, which program, when executed by a processor, is adapted to control a method comprising: receiving projection data, receiving motion vector field data, dividing the motion vector field data into a number of layers of motion vector field data, generating motion compensated projection data by projecting at least one of the number of layered motion vector field data onto the projection data and performing a motion compensation in the projection plane applying a two dimensional motion compensation on the projection, and generating image data of at least one voxel by back-projecting the movement compensated projection data.

According to an exemplary embodiment a program element for producing an image based on projection data of a tomography system, which program, when executed by a processor, is adapted to control a method comprising: receiving projection data, receiving motion vector field data, dividing the motion vector field data into a number of layers of motion vector field data, generating motion compensated projection data by projecting at least one of the number of layered motion vector field data onto the projection data, applying a two dimensional motion compensation on the projection, and generating image data of at least one voxel by back-projecting the movement compensated projection data.

The motion vector field data may be generated in a first routine. This first routine may comprise the step of a reconstruction of several three-dimensional images of an object of interest, e.g. of a heart. For example three three-dimensional voxel representations may be reconstructed relating to different phases of the heart cycle, e.g. to 15%, 30% and 45% of the so called RR-cycle. The RR-cycle is sometimes also expressed as cardiac cycle, describing the time covering a full heartbeat. By using these three voxel representations a three-dimensional motion vector field may be generated, e.g. with a known algorithm, by an estimation of the motion between phase 30% and 15% and an estimation of the motion between 30% and 45%, for example. Of course more than three three-dimensional voxel representations may be used to generate the three-dimensional motion vector field, which may lead to a motion vector field which is better adapted to the real motion of the heart.

After the generation of the three-dimensional motion vector field this motion vector field may be used to generate motion compensated image data. This may be done by processing all projection data again relating to the RR-cycle between 15% and 45%, for example the projection data of a projection may be used, which projection corresponds to the RR-phase of 18%. Accordingly the motion vector field corresponding to the motion between 30% and 15% RR-cycle may be used. Optionally the motion vector field can be scaled by a factor, e.g. by 0.8. In a further step this motion vector field, relating to 30% to 15%, may be divided into a number of N layers each having a surface normal which is parallel to the direction of the projection the projection data were detected with. For all voxels belonging to a layer 1, wherein 1 is an element of the interval having 0 and N as borders, the motion vector field may be projected onto the projection data before the back-projecting is done. This projection of the motion vector field may be performed under consideration of the beam geometry under which the projection data were taken. The two-dimensional motion vector field resulting from this projection may be used to perform the movement compensation, i.e. to compensate motion artefacts in the reconstructed volume by cancelling the motion, on the projection data. A possible movement compensation is described in the publication “Reduction of patient motion artefacts in digital subtraction angiography: evaluation of a fast and fully automatic technique”, Meijering MH et al., Radiology 2001 April; 219(1), pages 288 to 293; and in the references cited therein. That is, the two-dimensional motion vector field may be used to distort the projection data in such a way that the movement compensation is performed. The projection data may be pre-processed and/or filtered before the movement compensation is performed. Since the projection data are already movement compensated after this step, standard back-projection processes, e.g. standard back-projection geometries, may be used to generate the voxels belonging to the layer 1. A back-projection process which can be used in connection with this invention is described in “Helical cardiac cone beam reconstruction using retrospective ECG gating”, M. Grass et al., Physics in Medicine and Biology 48 (2003) pages 3069 to 3084, for instance. For generating the voxels of the next layer l+1 a new distorted projection may be calculated by using the steps corresponding to the steps described above followed by a back-projecting step using standard back-projecting geometry as well. Optional a method may be used in which not single layers of the motion vector field are used but averaged layers of the motion vector field. The averaging may be performed by averaging motion vectors of several layers of the motion vector field. These averaged motion vector fields may be particularly advantageous to generate interpolated distorted projections for voxels in a transient area between the layers. In particular in the case that the motion vector field is determined only at few supporting points, it might be unnecessary to calculate new distorted projections.

The examination of the object of interest, e.g. the analysis of multi-cycle cardiac computer tomography data according to the invention, may be realized by the computer program, i.e. by software, or by using one or more special electronic optimization circuits, i.e. in hardware, or in hybrid form, i.e. by means of software components and hardware components. The computer program may be written in any suitable programming language, such as, for example, C++ and may be stored on a computer-readable medium, such as a CD-ROM. Also, the computer program may be available from a network, such as the WorldWideWeb, from which it may be downloaded into image processing units or processors, or any suitable computers.

By using the method according to an exemplary embodiment of the invention it may be possible reduce the complexity of the reconstruction procedure, since it may be no longer necessary to integrate the integration of the motion vector field into the back-projection step. Contrary to this, according to the prior art a given motion vector field, being estimated for a data set to be reconstructed, usually may cover a full three-dimensional field of view. Moreover, according to an exemplary embodiment the image quality may be increased, since the motion compensation can be applied before a possible projection filtering. Thus, a fast and efficient method for motion compensation may be provided, which may be compliant with current back-projection architectures. Thus, back-projection architectures known in the state of the art may be used. According to an exemplary embodiment it may be possible that the computational load of the motion compensation process is not represented in a modification of the back projection loop itself, but in the projection pre-processing. Recapitulating it might be possible to provide a high quality reconstruction, e.g. a cardiac reconstruction, of moving structures with improved temporal resolution, decreased blurring, improved Signal-To-Noise level. Further, it might be possible to decrease a radiation dose when using a method according to an exemplary embodiment. By projecting the layers of the motion vector field onto the projection data layers of movement compensated projection data can be generated.

In the following, further exemplary embodiments of the method for movement compensation of image data of an object of interest will be described. However, these embodiments apply also for the reconstruction unit, for the tomography system, for the computer-readable medium, and for the program element.

According to another exemplary embodiment of the method the dividing into layers is done in such a way that the layers having a surface normal parallel to the direction of the projection utilized to generate the projection data. For example, the layers can be layers in the x-y plane in case the central ray from the projection, i.e. the detector plane towards the radiation source, is in the z-direction.

According to yet another exemplary embodiment of the method the movement compensated projection data generated by projecting the two closest layers are used for generating the image data of the at least one voxel. Such an embodiment may be especially advantageous when a voxel is located in the transient area between two layers of the motion vector field.

According to still another exemplary embodiment in the method a back-projecting architecture using Cartesian coordinates is used. The use of Cartesian coordinates may permit the use of an easy and fast back-projection algorithm. In particular the use of hard-wired circuits might be enabled.

According to yet still another exemplary embodiment of the method the number of layers is chosen dependent on a predetermined accuracy of the image data. The number of layers the motion vector field is divided in is chosen in such a way that in one layer, i.e. over the thickness of one layer, the variations in movement is sufficient low to achieve the desired resolution. On the other hand the number of layers might not be chosen to be to large, since then the needed storage capacity for the data might be to high.

In the following, further exemplary embodiments of the reconstruction unit will be described. However, these embodiments apply also for the method, for the tomography system, for the computer-readable medium, and for the program element.

According to a further exemplary embodiment the reconstruction unit comprises a hard-wired circuit, which is adapted to accomplish the back-projecting. The use of a hard-wired circuit, e.g. a hardware implementation, may provide for an easy implementation. Further, such a hard-wired circuit might be failure resistant. Instead of a hard-wired circuit a reconstruction unit comprising a processor including suitable software might be used.

According to still a further exemplary embodiment the reconstruction unit further comprising a storage unit. The storage unit might be adapted to store, at least temporary, the projection data, the motion vector field data, the layers of the motion vector field data and/or the motion compensated projection data.

It should be noted in this context, that the present invention is not limited to computer tomography, but may always then be applied when motion compensation during reconstruction of a multi-dimensional data set has to be performed.

It should also be noted that this technique may also be useful for other medical imaging modalities like C-arm based 3D rotational X-ray imaging, magnetic resonance imaging, positron emission tomography or other imaging modalities employing ray based back projection reconstruction methods. Moreover, in addition to cardiac imaging all other tomographic imaging applications for moving objects, like e.g. breathing gated imaging or others may profit from this approach.

It may be seen as the gist of an exemplary embodiment of the present invention that a given three-dimensional motion vector field m/(x,y,z, t,t₀) of a scanned object, which describes the motion of the object at a time point t with respect to the reference state t₀ can be subdivided into two-dimensional motion vector field layers m(x,y,l,t,t₀), wherein l indicates the label. The dividing is done perpendicular to the direction of the central ray from the projection p(u,v,t) towards a radiation source of a tomography unit. In the above given description of the layer of the motion vector field the central ray from the projection to the source is chosen parallel to the z-axis. The number of layers is preferably chosen depending on the accuracy to be achieved and the coarseness of the three-dimensional motion vector field. The two-dimensional motion vector field, corresponding to the motion of all voxels contained in the respective layer, is forward projected onto the projection p(u,v,t) under consideration, leading to a two-dimensional motion vector field m(u,v,l,t,t₀).

This two-dimensional vector field m(u,v,l,t,t₀) is then employed to calculate a motion compensated projection p(u,v,l,t,t₀) of the object. The back-projection of a voxel v(x,y,z) contained in the layer 1, then employs the motion compensated projection p(u,v,l,t,t0) itself, or, in case of overlapping layers or voxel in the transient area between two motion vector field layers, those two motion compensated projections with smallest distance to the voxel. This back-projection of the voxel v(x,y,z) is already motion compensated due to the fact that the motion vector fields are employed to generate the projection p(u,v,l,t,t₀). Furthermore, the motion compensation can be carried out on the projections before filtering so that no additional approximations may be added to the inversion process, i.e. the back-projecting.

One basic idea may be seen in the fact that the movement compensation is done before the back-projecting is performed and furthermore the movement is compensated for rather for a whole layer at once than for each single voxel.

These and other aspects of the present invention will become apparent from and elucidated with reference to the embodiments described hereinafter.

Exemplary embodiments of the present invention will be described in the following, with reference to the following drawings.

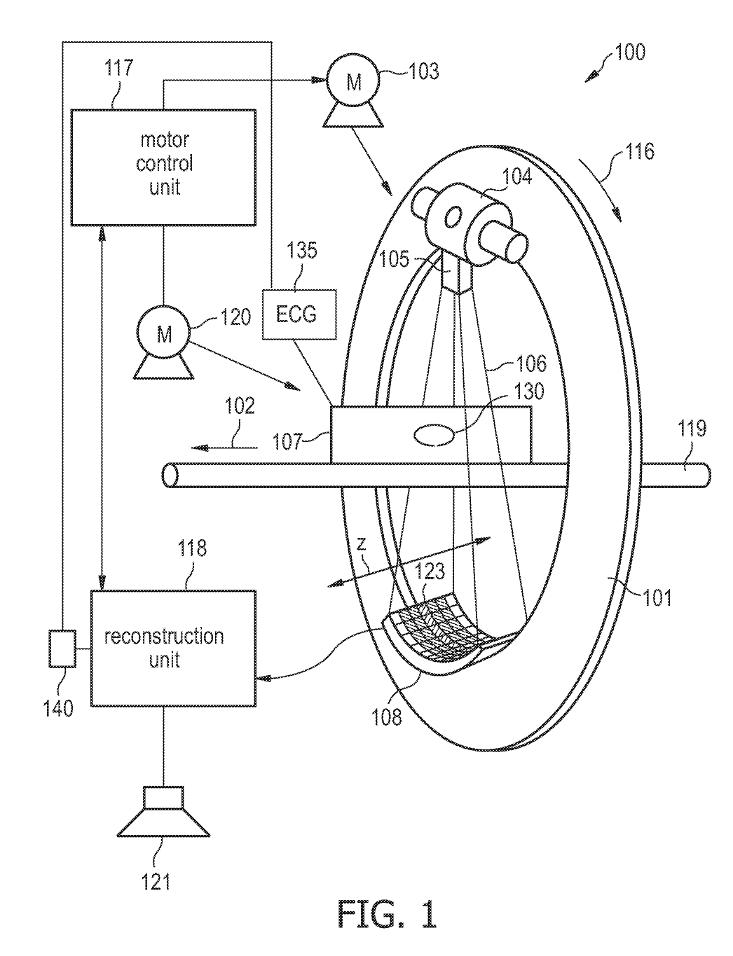

FIG. 1 shows a simplified schematic representation of an computer tomography system according to an exemplary embodiment of the present invention.

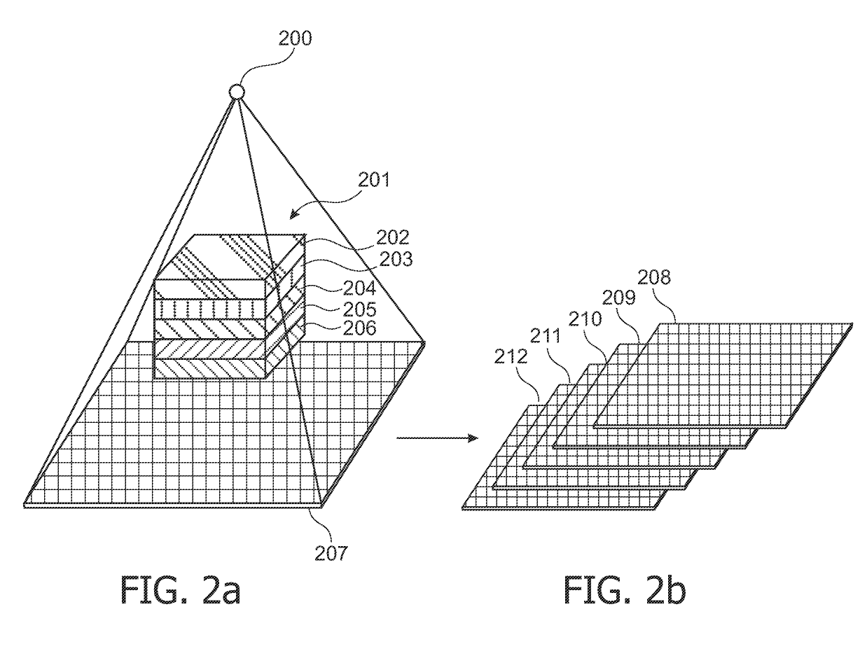

FIG. 2 shows a schematic representation of a layered 3D motion vector field and a detector plane.

The illustration in the drawings is schematically. In different drawings, similar or identical elements are provided with the same reference signs.

FIG. 1 shows an exemplary embodiment of a computed tomography scanner system which can be used in connection with a reconstruction unit according an embodiment of the invention.

The computer tomography apparatus 100 depicted in FIG. 1 is a cone-beam CT scanner. However, the invention may also be carried out with a fan-beam geometry. The CT scanner depicted in FIG. 1 comprises a gantry 101, which is rotatable around a rotational axis 102. The gantry 101 is driven by means of a motor 103. Reference numeral 104 designates a source of radiation such as an X-ray source, which, according to an aspect of the present invention, emits polychromatic or monochromatic radiation.

Reference numeral 105 designates an aperture system which forms the radiation beam emitted from the radiation source to a cone-shaped radiation beam 106. The cone-beam 106 is directed such that it penetrates an object of interest 107 arranged in the center of the gantry 101, i.e. in an examination region of the CT scanner, and impinges onto the detector 108. As may be taken from FIG. 1, the detector 108 is arranged on the gantry 101 opposite to the source of radiation 104, such that the surface of the detector 108 is covered by the cone beam 106. The detector 108 depicted in FIG. 1 comprises a plurality of detector elements 123 each capable of detecting X-rays which have been scattered by, attenuated by or passed through the object of interest 107. The detector 108 schematically shown in FIG. 1 is a two-dimensional detector, i.e. the individual detector elements are arranged in a plane, such detectors are used in so called cone-beam tomography. It is also possible to use a one-dimensional detector arrangement.

During scanning the object of interest 107, the source of radiation 104, the aperture system 105 and the detector 108 are rotated along the gantry 101 in the direction indicated by an arrow 116. For rotation of the gantry 101 with the source of radiation 104, the aperture system 105 and the detector 108, the motor 103 is connected to a motor control unit 117, which is connected to a control unit 118 (which might also be denoted as a calculation, reconstruction or determination unit).

In FIG. 1, the object of interest 107 is a human being which is disposed on an operation table 119. During the scan of a heart 130 of the human being 107, while the gantry 101 rotates around the human being 107, the operation table 119 displaces the human being 107 along a direction parallel to the rotational axis 102 of the gantry 101. By this, the heart 130 is scanned along a helical scan path. The operation table 119 may also be stopped during the scans to thereby measure signal slices. It should be noted that in all of the described cases it is also possible to perform a circular scan, where there is no displacement in a direction parallel to the rotational axis 102, but only the rotation of the gantry 101 around the rotational axis 102.

Optionally, an electrocardiogram device 135 can be provided which measures an electrocardiogram of the heart 130 of the human being 107 while X-rays attenuated by passing the heart 130 are detected by detector 108. The data related to the measured electrocardiogram are transmitted to the control unit 118.

Further, it shall be emphasized that, as an alternative to the cone-beam configuration shown in FIG. 1, the invention can be realized by a fan-beam configuration. In order to generate a primary fan-beam, the aperture system 105 can be configured as a slit collimator.

The detector 108 is connected to the control unit 118. The control unit 118 receives the detection result, i.e. the read-outs from the detector elements 123 of the detector 108 and determines a scanning result on the basis of these read-outs. Furthermore, the control unit 118 communicates with the motor control unit 117 in order to coordinate the movement of the gantry 101 with motors 103 and 120 with the operation table 11.

The control unit 118 may be adapted for reconstructing an image from read-outs of the detector 108. A reconstructed image generated by the control unit 118 may be output to a display (not shown in FIG. 1) via an interface 122.

The control unit 118 may be realized by a data processor to process read-outs from the detector elements 123 of the detector 108.

The computer tomography apparatus shown in FIG. 1 captures multi-cycle cardiac computer tomography data of the heart 130. In other words, when the gantry 101 rotates and when the operation table 119 is shifted linearly, then a helical scan is performed by the X-ray source 104 and the detector 108 with respect to the heart 130. During this helical scan, the heart 130 may beat a plurality of times and multiple RR-cycles are covered. During these beats, a plurality of cardiac computer tomography data are acquired. Simultaneously, an electrocardiogram may be measured by the electrocardiogram unit 135. After having acquired these data, the data are transferred to the control unit 118, and the measured data may be analyzed retrospectively.

The measured data, namely the cardiac computer tomography data and the electrocardiogram data are processed by the control unit 118 which may be further controlled via a graphical user-interface (GUI) 140. It should be noted, however, that the present invention is not limited to this specific data acquisition and reconstruction.

FIG. 2 schematically shows a layered representation of a three-dimensional vector field. FIG. 2a shows a radiation source 200 of a tomography system (not shown) and a reconstruction volume 201. The reconstruction volume is associated with a layered motion vector field, wherein in FIG. 2a individual layers of the motion vector field are labelled with the reference signs 202, 203, 204, 205, and 206. The layered representation of the three-dimensional motion vector field shown in FIG. 2 corresponds to a time point t at which a projection p(t) has been measured by a detector plane 207, schematically shown, i.e. the detector plane 207 measures the projection data corresponding to the volume, or object under examination schematically shown as volume 201.

When the individual motion vector fields are projected onto the measured projection data individual motion compensated projection layers result. These individual motion compensated vector layers are schematically shown in FIG. 2b. Due to the fact that the motion vector field is divided into five layers also five layers of motion compensated projection data are generated when the motion vector field is projected onto the projection data. These five layers are labelled 208, 209, 210, 211 and 212 in FIG. 2b and can be afterwards used to generate the image data, i.e. the voxels representing a three-dimensional image of a portion of the object under examination.

A full three-dimensional motion compensated reconstruction may be achieved with the described method for a target volume of interest or for the complete volume. It may be used to increase the temporal resolution of the data set or to decrease motion blurring. In addition, it may help to use wider gating windows in cardiac CT imaging which may lead to an increased signal-to-noise ratio.

According to an aspect of the present invention, high quality cardiac reconstruction of target structures may be performed with improved temporal resolution, decreased motion blurring or improved signal-to-noise ratio or decreased dose.

It should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

1. A method for movement compensation of image data of an object of interest, the method comprising:
receiving projection data, representing the object of interest;
receiving motion vector field data;
dividing the motion vector field data into a number of layers of motion vector field data;
generating motion compensated projection data by projecting at least one of the number of layered motion vector field data onto the projection data and applying a two dimensional motion compensation; and
generating image data of at least one voxel by back-projecting the movement compensated projection data.

2. The method according claim 1, wherein the dividing is done in layers having a surface normal parallel to the direction of the projection.

3. The method according claim 1, wherein in the generating of the image data of the at least one voxel the movement compensated projection data generated by projecting the two closest layers are used.

4. The method according to claim 1, using Cartesian coordinates in the back-projecting.

5. The method according to claim 2, choosing the number of layers depending on a predetermined accuracy of the image data.

6. A reconstruction unit for an examination apparatus for examination of an object of interest, wherein the reconstruction unit is adapted to:
receiving projection data;
receiving motion vector field data;
dividing the motion vector field data into a number of layers of motion vector field data;
generating motion compensated projection data by projecting at least one of the number of layered motion vector field data onto the projection data and applying a two dimensional motion compensation; and
generating image data of at least one voxel by back-projecting the movement compensated projection data.

7. The reconstruction unit of claim 6, comprising:
a hard-wired circuit, which is adapted to accomplish the back-projecting.

8. The reconstruction unit according claim 6, further comprising:
a storage unit.

9. A tomography system comprising:
a tomography unit; and
a reconstruction unit according to claim 6,
wherein the tomography unit is adapted to measure projection data of an object of interest and further adapted to transmit the projection data to the reconstruction unit.

10. A computer readable medium in which a program for producing an image based on projection data of a tomography system is stored, which program, when executed by a processor, is adapted to control a method comprising:
receiving projection data;
receiving motion vector field data;
dividing the motion vector field data into a number of layers of motion vector field data;
generating motion compensated projection data by projecting at least one of the number of layered motion vector field data onto the projection data and applying a two dimensional motion compensation method on the projection; and
generating image data of at least one voxel by back-projecting the movement compensated projection data.

11. A program element for producing an image based on projection data of a tomography system, which program, when executed by a processor, is adapted to control a method comprising:
receiving projection data;
receiving motion vector field data;
dividing the motion vector field data into a number of layers of motion vector field data;
generating motion compensated projection data by projecting at least one of the number of layered motion vector field data onto the projection data and applying a two dimensional motion compensation on the projection; and
generating image data of at least one voxel by back-projecting the movement compensated projection data.
